(19) United States
(12) Patent Application Publication
(10) Pub. No.: US 2019/0199840 A1
(43) Pub. Date: Jun. 27, 2019

(54) WHISPER DEVICE

(71) Applicant: WENDY PEDERSEN, Ammon, ID (US)

(72) Inventor: WENDY PEDERSEN, Ammon, ID (US)

(21) Appl. No.: 16/195,806

(22) Filed: Nov. 19, 2018

Related U.S. Application Data
(60) Provisional application No. 62/587,601, filed on Nov. 17, 2017.

(51) Int. Cl. H04M 1/19; H04M 1/60; G10L 21/0364; H04M 1/725

(52) U.S. Cl. CPC H04M 1/19; H04M 1/725; G10L 21/0364; H04M 1/60

(57) ABSTRACT

A voice enhancement device includes a housing and a channel within the interior of the housing that is designed to carry, amplify, or otherwise enhance sound that travels therethrough.

### BACKGROUND

Learning to read can be difficult for a child. Especially for the child that stumbles in attempting to pronunciate the words, the process of learning to read can start to feel overwhelming. Particularly challenging are words that contain spellings that are not phonetically correct. For example, “was” is pronounced “wuz”, “is” is pronounced “iz”, and “the” is pronounced “thuh”.

One way to encourage young readers to advance in reading is to have them learn a few sight words such as “was”, “is”, and “the”, along with consonants and short vowel sounds. Moreover, if a child has the skills and tools to sound out a word, the child can more easily recognize that words that look the same may not actually be pronounced the same way. Consequently, tools that help children to learn to read are needed.

### SUMMARY

An exemplary device includes a housing with a channel extending therethrough. At least a first opening is located at or near a top end of the housing. At least a second opening is located at or near a bottom end of the housing, the second opening being smaller than the first opening. The channel extends between the first and second openings, the channel being configured to carry sounds that travel from the second opening to the first opening.

An exemplary device further includes that the channel be configured to modify sounds that travel therethrough. For example, the channel may be designed to modify acoustics, frequencies, resonance, pitches, or other features of sound. The channel may further be designed to take into account sound frequency and sound quality.

In this manner, children may hear the sounds that they are making in a role-playing context. The device has further applications in other fields of use as well.

### BRIEF DESCRIPTION OF DRAWINGS

FIG. 1 illustrates a perspective view of an example voice enhancement device that is provided in the form of a mobile phone.

FIG. 2 illustrates a perspective view of two halves of an enhancement device.

FIG. 3 illustrates a front view of a voice enhancement device.

### DETAILED DESCRIPTION

The following relates to a voice enhancement device. Particularly in the field of education, the device enhances sounds to serve as a phonetic reader for children to more easily grasp pronunciation of words, such as vowel sounds, consonant sounds, syllable stress, and intonation. Also, the device may assist in segmenting and blending words. The devices may also be used in the field of speech therapy, for example, helping children with a lisp, or other speech impediment, to grasp and correct sounds.

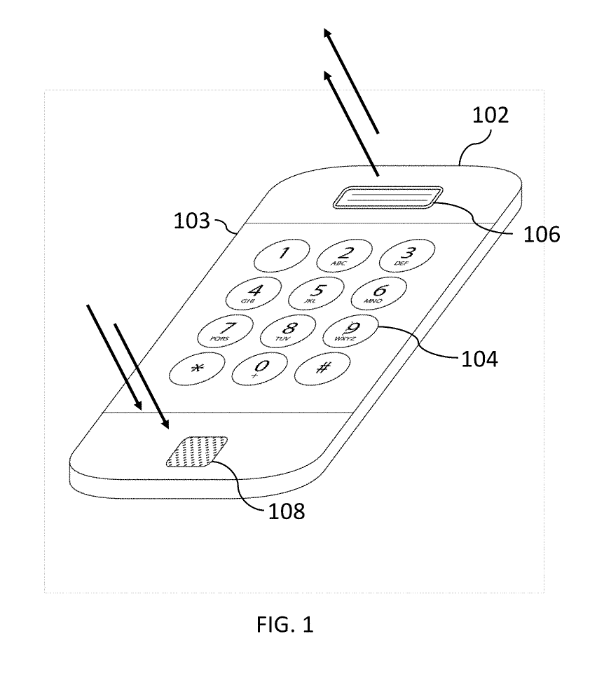

As shown in FIG. 1, an example device 102 is shaped as a mobile phone or tablet, or other electronic device, enabling a child to use the electronic looking device to engage in role play. This type of techie role-playing environment is believed to facilitate an enjoyable learning experience and augment the learning process.

The device 102 includes a housing 103 with a first opening 106 located at or near a top end and at least a second opening 108 located at or near a bottom end. The second opening 108 is dimensioned for a child's voice to communicate sound therethrough as indicated by the two black arrows. The second opening 108 is designed to mimic a home button of a phone by having a square-like shape or other shape (e.g., circle, oval shape, etc.). Although a smart device appearance with a home button is used, the second opening 108 is actually a microphone in the sense that it communicates sound through the device to be amplified. Alternative designs include that the second opening 108 have a length that is similar to the length of the housing 103. The height may also vary with respect to the height of the housing.

The first opening 106 is located at or near a top end of the housing 103. The first opening 106 is dimensioned to communicate sound therethrough, the sound originating from the second opening 108, passing through the housing, and then being communicated to an external environment outside the housing 103. The second opening 108 is designed to mimic a receiver or front microphone of a smart device by being located at or near the top end of the device. The shape of the opening may be rectangular as shown. Alternative shapes are also anticipated (e.g., circle, oval shape, etc.).

The device may include additional features that emulate a smart device, such as user interface controls 104, touch-like screen, or other types of interface elements and other elements associated with a smart device, tablet, and other electronic devices. The device may include lights, colors, and other look and feel features that make the device seem like a smart device. Also, the dimensions of the housing may be similar to that of mobile phones or tablets.

The device 102 shown includes a housing with a channel extending therethrough. The channel is configured to modify sounds that travel therethrough. For example, the channel may be designed to modify acoustics, frequencies, resonance, pitches, or other features of sound. The channel may further be designed to take into account sound frequency and sound quality. This may be accomplished by having appropriate dimensions, curvature, angles, and materials.

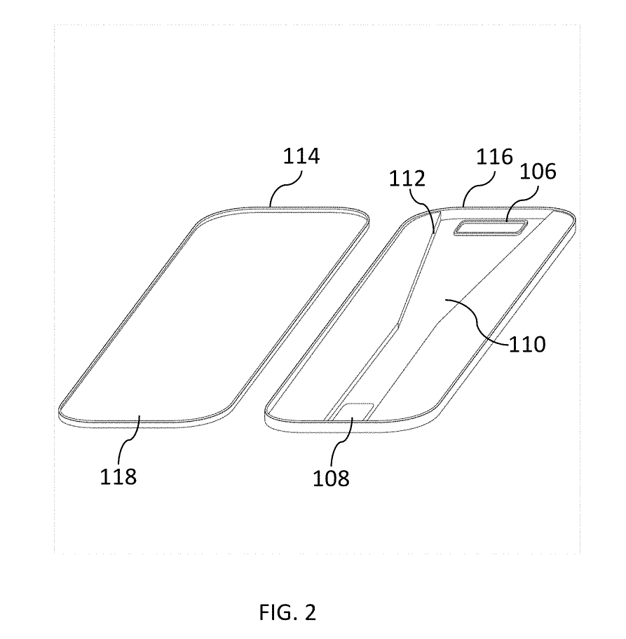

Turning to FIG. 2, the example channel 110 shown is a conduit that extends between the first and second openings, the channel 110 being configured to carry sounds that travel from the second opening 108 to the first opening 106. Particularly, the channel is configured to amplify sounds that travel from the second opening 108 to the first opening 106 by having a smaller opening at the second opening 108 and a larger opening at the first opening 106, with the channel expanding in cross sectional area from the second opening 108 to the first opening 106.

As shown in FIG. 2, the housing may be defined by first 114 and second 116 halves that are bonded together. The channel 110 is defined by at least a portion of the first half 114 and the second half 116. The channel is further defined by interior sidewalls 112 that are located within the interior of the housing and that extend between the first half 114 and the second half 116. The sidewalls may be aligned perpendicular to one or more of the first 114 and second half 116. Alternatively, one or more sidewalls may extend obliquely relative to the first and second half.

Alternatives include that both the first and second half include portions of the interior sidewalls. Also, the channel may be a separate component that is attached within the housing. An example channel may be removable from the housing.

An example device includes a solid housing or at least a portion of the housing that is made of a solid material and the channel is cut out of the solid material. The sidewalls and the housing may include porous material or other features that affect sound. Other variations are anticipated that define a channel.

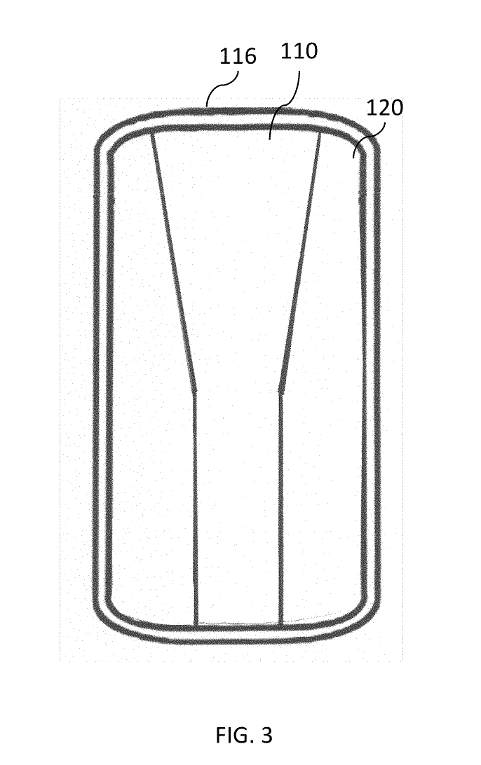

Turning to FIG. 3, a front view of the interior of the housing shows that the sidewalls begin at the second opening located at the bottom of the housing, the sidewalls extending in parallel manner to form a first portion that includes a straight narrow section towards the top of the housing. At some point along a length of the housing, both of the sidewalls branch outward, or taper outward, from each other. The sidewalls may taper at same or similar angles relative to each other or to a central axis of the housing that extends from top to bottom, branching out to form a greater channel cross-section, the angled portion being a second portion. The second portion may remain angled or straighten out to form parallel lines. Ends of the second portion terminate at the top opening. The channel is configured to carry the sound, and in some embodiments, configured to modify sound as described herein.

The point of branching outward may occur midway, or approximately midway, along the length of the housing. The point of angle departure may occur at, for example, ¼, ⅓, ½, 2/4, ⅝, ⅞, or other locations along a length of the channel. Other points are also anticipated.

The relative angle to the central axis may be 20-25, 25-30, 30-35, 35-40, 40-45, 45-50, 50-60, 60-65, 65-70, 70-80, and 80-85 degrees. The tapered section may include sidewalls that are the same angle from a central axis of the housing, or alternatively, that are different angles, one angle being greater than the other angle.

The branching out of the channel may be a sharp angle, or it may by curved. Configurations are anticipated to further sound enhancement. For example, the sidewalls may include additional angles, curvature, step-like configurations, or other configurations can be used. The sidewalls may be of planar construction, being flat and plate-like. Other constructions include curved walls.

Instead of sidewalls, alternatives include that a tube extend from the top and bottom side within the housing. The tube may increase in diameter at a location along the length of the tube, for example, at a midway point or other point. Examples include ¼, ⅓, ½, ⅔, ¾, ⅝, and ⅞ of the way. Other points are also anticipated. An exemplary shape of the tube includes one or more of a tubular, frusto conical, and funnel shape.

The openings 108 and 106 for communicating sound may include one opening, or alternatively, a plurality of small holes.

For a device that includes a phone-like appearance, the second opening and the first opening, referred to also as a mouthpiece and ear hole, may be located opposite each other, the mouthpiece at the bottom of the housing, facing outward from the housing on the distal facing surface of the bottom side. Alternatively, the mouthpiece may be located substantially near the bottom side, facing away from the housing on the front side of the housing. Specifically, the mouthpiece may be 0-0.25 cm, 0.25-0.50 cm, 0.50-1.0 cm, and so forth, away the bottom side of the housing.

Similarly, the ear hole may be located at the top of the housing, facing outward from the housing on the proximal facing surface of the top side. Alternatively, the earhole may be located substantially near the top side, facing away from the housing on the front side of the housing. Specifically, the mouthpiece may be 0-0.25 cm, 0.25-0.50 cm, 0.50-1.0 cm, and so forth, away the top side of the housing.

The mouthpiece and earhole may be raised from the device. The mouthpiece and earhole may include rounded surfaces, or alternatively, recesses within the housing.

The material of the housing may comprise plastic, metal, a combination thereof, or other material known in the art. The material of the channel may be the same as the material of the housing. The channel may further include an inlay or layer of other material, such as thin silver, copper, wood, or other material. Also, the channel may not include material that is the same as that for the housing.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A voice enhancement device comprising:
a housing;
at least a first opening at or near a top end of the housing;
at least a second opening at or near a bottom end of the housing, the second opening being smaller than the first opening; and
a channel within the housing that extends between the first and second openings, the channel configured to carry sounds that travel from the second opening to the first opening.

2. The enhancement device in claim 1, wherein the channel is configured to amplify sounds that travel from the second opening to the first opening.

3. The enhancement device in claim 1, wherein the channel is configured to modify human voice sounds in a manner that benefits listening by a human ear.

4. The enhancement device in claim 1, wherein the housing comprises a top side, a bottom side, front side, back side, and end walls that attach to outer edges of the top side and bottom side, the channel defined by at least a portion of the front side and back side and interior sidewalls of the housing.

5. The enhancement device in claim 3, wherein the sidewalls extend between the top side to the bottom side.

6. The enhancement device in claim 3, wherein the sidewalls extend in a parallel manner with respect to top and bottom sides.

7. The enhancement device in claim 3, wherein the sidewalls are angled with respect to the top and bottom sides.

8. The enhancement device in claim 3, wherein the sidewalls are of planar construction.

9. The enhancement device in claim 3, wherein the sidewalls are curved.

10. The enhancement device in claim 1, wherein the channel is defined by an inner tubing that graduates in diameter.

11. The enhancement device in claim 1, wherein the channel includes a frusto conical shape.

12. The enhancement device in claim 1, wherein the channel includes a tapered section.

13. The enhancement device in claim 1, wherein the channel includes a straight narrow section that branches outward.

14. The enhancement device in claim 1, wherein the second opening includes a mouthpiece with small holes.

15. The enhancement device in claim 1, wherein the first opening includes an ear hole.

16. The enhancement device in claim 1, wherein the housing includes one or more features that are similar to a cellular phone.

17. The enhancement device in claim 1, wherein the housing includes an outer surface that includes an image of a touch-like screen found on mobile phones and tablets.

18. The enhancement device in claim 1, wherein dimensions of the housing are similar to that of mobile phones or tablets.

19. The enhancement device in claim 1, further comprising a protective case for the housing that is similar to that of mobile phones or tablets.

20. The enhancement device in claim 1, further comprising decorative stickers that can be placed on an outer surface of the housing.
